(19) United States
(12) Patent Application Publication
(10) Pub. No.: US 2026/0269762 A1
(43) Pub. Date: Sep. 10, 2026

(54) ACTIVE SHORT CIRCUIT FAULT STRATEGY WITH EXTERNAL CONTROLLER

(71) Applicant: Caterpillar Inc., Peoria, IL (US)

(72) Inventors: John Edmund Young, East Peoria (IL); Venkata Ramakrishna Challa, Narasaraopet (IN); Ponkamali Paramasivan, Coimbatore (IN); Jackson Wai, Dunlap, IL (US); Ahmed Khalil, Dunlap, IL (US); Richard G. Auch, Peoria, IL (US)

(73) Assignee: Caterpillar Inc., Peoria, IL (US)

(21) Appl. No.: 19/071,029

(22) Filed: Mar. 5, 2025

(51) Int. Cl. H02P 29/024; B60L 3/00; H02P 27/06

(52) U.S. Cl. CPC H02P 29/0241; B60L 3/003; H02P 27/06

(57) ABSTRACT

An electric circuit for an electric motor includes a switching inverter circuit an external controller and an Active Short (ASC) Fault circuit. The switching inverter circuit includes a set of top IGBTs and a set of bottom IGBTs configured to provide energy to the electric motor. The external controller is configured to control switching of the top and bottom IGBTs in normal operation, and activate one of the set of top IGBTs or the bottom IGBTs in response to detecting an event in which rotor speed of the electric motor exceeds a specified threshold speed. The ASC Fault circuit is configured to detect an overvoltage fault; determine if rotor speed of the electric motor exceeds the specified threshold speed; and activate one of the set of top IGBTs or the set of bottom IGBTs when the overvoltage fault is present and the rotor speed is less than the threshold speed.

### TECHNICAL FIELD

This document relates to electric powered work machines and in particular to techniques to improve performance and safety of the electric motors of electric work machines.

### BACKGROUND

Electric powered large moving work machines (e.g., wheel loaders, mining trucks, etc.) use large capacity energy sources to drive one or more electric motors. Back electromotive force (EMF), also known as counter-electromotive force, is a phenomenon that occurs in electric motors and generators. EMF can include an induced voltage that opposes the primary voltage applied to an electric motor or generator. In electric motors, back-EMF is created when the motor's armature rotates in the magnetic field. As the armature coils move through this field, they generate a voltage according to Faraday's law of induction. This induced voltage opposes the applied voltage that is driving the motor, hence the term “back” or “counter” EMF. Back-EMF limits the motor's speed. In a back-EMF failure mode, the speed control system of the electric motor fails and the loss of speed control can cause freewheeling current to occur. The freewheeling current can cause regenerative effects, such as charging a direct current (DC) bus above a maximum allowable voltage. U.S. Pat. No. 10,110,154 relates to a controller to drive an inverter circuit for a permanent magnet synchronous motor.

### SUMMARY OF THE INVENTION

Large electric powered work machines can include high current and voltage electric motors. Electrical circuits for the work machines include high power converter circuits that convert the DC energy from the energy source to AC energy to power the electric motors of a work machine. In the event of failure of a high power electric motor, it is desired to minimize damage to equipment of the work machine.

An example electric circuit for an electric motor includes a switching inverter circuit, an external controller, and an Active Short Circuit (ASC) Fault circuit. The switching inverter circuit includes a set of top Insulated Gate Bipolar Transistors (IGBTs) and a set of bottom IGBTs configured to provide energy to the electric motor. The external controller is configured to control switching of the top and bottom IGBTs in normal operation and activate one of the set of top IGBTs or the bottom IGBTs in response to detecting an event in which rotor speed of the electric motor exceeds a specified threshold speed. The ASC Fault circuit is configured to detect an overvoltage fault; determine if rotor speed of the electric motor exceeds the specified threshold speed; and activate one of the set of top IGBTs or the set of bottom IGBTs when the overvoltage fault is present and the rotor speed is less than the threshold speed.

An example method of operating an inverter circuit of an electric motor includes monitoring for faults of the inverter circuit using an ASC Fault circuit; detecting an overvoltage fault using the ASC Fault circuit; determining whether a rotor speed of the electric motor is greater than a specified threshold speed using an external controller external to the invert circuit; and activating a default set of one of top insulated gate bipolar transistor (IGBT) drivers or bottom IGBT drivers when the overvoltage fault is present and the rotor speed of the electric motor is less than the threshold speed.

An example fault-detection circuit for an electric motor includes an external controller including a top insulated gate bipolar transistor (IGBT) control signal output and a bottom IGBT control signal output for IGBT devices of a switching inverter circuit, and configured to activate one of the top IGBT control signal output or the bottom IGBT control signal output in response to detecting rotor speed of electric motor that exceeds a specified threshold speed; and an ASC Fault circuit. The ASC Fault circuit is configured to determine an overvoltage fault for the switching inverter circuit; determine when rotor speed of the electric motor exceeds the specified threshold speed; and activate a default set of one of the set of top IGBTs or the set of bottom IGBTs when the overvoltage fault is present and the rotor speed is less than the specified threshold speed.

### BRIEF DESCRIPTION OF THE DRAWINGS

FIG. 1 is an elevation view depicting an example work machine in accordance with this disclosure.

FIG. 2 is an illustration of an operating curve for an electric motor in accordance with this disclosure.

FIG. 3 is a circuit diagram of an example of portions of a switching inverter circuit for a three-phase alternating current (AC) electric motor in accordance with this disclosure.

FIG. 4 is a circuit diagram of an example of an inverter circuit operating in Active Short Circuit (ASC) mode in accordance with this disclosure.

FIG. 5 is an illustration of examples of phase current transients when the inverter circuit of FIG. 3 operates in ASC mode in accordance with this disclosure.

FIG. 6 is an example of a logic diagram for inverter circuit fault detection that can be implemented by an external controller in accordance with this disclosure.

FIG. 7 is a circuit diagram of an example of logic circuitry to implement the logic diagram of FIG. 6 in accordance with this disclosure.

FIG. 8 is a flow diagram of an example of a method of operating an inverter circuit of an electric motor in accordance with this disclosure.

### DETAILED DESCRIPTION

Examples according to this disclosure are directed to electric circuits and methods that detect faults in operation of high output electric motors.

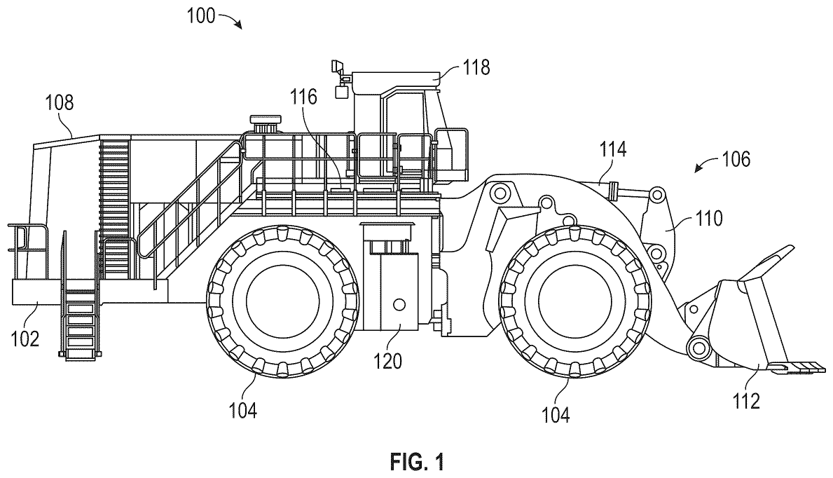

FIG. 1 depicts an example machine 100 in accordance with this disclosure. In FIG. 1, machine 100 includes frame 102, wheels 104, implement 106, and a speed control system implemented in one or more on-board electronic devices like, for example, an electronic control unit or ECU. Example machine 100 is a wheel loader. In other examples, however, the machine may be other types of machines related to various industries, including, as examples, construction, agriculture, forestry, transportation, material handling, waste management, marine, stationary power, and so on. Accordingly, although some examples are described with reference to a wheel loader machine, examples according to this disclosure are also applicable to other types of machines including graders, scrapers, dozers, excavators, compactors, material haulers like dump trucks, marine vessels, locomotives, along with other example machine types.

Machine 100 includes frame 102 mounted on four wheels 104, although, in other examples, the machine could have more than four wheels. Frame 102 is configured to support and/or mount one or more components of machine 100. For example, machine 100 includes enclosure 108 coupled to frame 102. Enclosure 108 can house, among other components, an electric motor to propel the machine over various terrain via wheels 104. In some examples, multiple electric motors are included in multiple enclosures at multiple locations of the machine 100.

Machine 100 includes implement 106 coupled to the frame 102 through linkage assembly 110, which is configured to be actuated to articulate bucket 112 of implement 106. Bucket 112 of implement 106 may be configured to transfer material such as, soil or debris, from one location to another. Linkage assembly 110 can include one or more cylinders 114 configured to be actuated hydraulically or pneumatically, for example, to articulate bucket 112. For example, linkage assembly 110 can be actuated by cylinders 114 to raise and lower and/or rotate bucket 112 relative to frame 102 of machine 100.

Platform 116 is coupled to frame 102 and provides access to various locations on machine 100 for operational and/or maintenance purposes. Machine 100 also includes an operator cabin 118, which can be open or enclosed and may be accessed via platform 116. Operator cabin 118 may include one or more control devices (not shown) such as, a joystick, a steering wheel, pedals, levers, buttons, switches, among other examples. The control devices are configured to enable the operator to control machine 100 and/or the implement 106. Operator cabin 118 may also include an operator interface such as, a display device, a sound source, a light source, or a combination thereof.

Machine 100 can be used in a variety of industrial, construction, commercial or other applications. Machine 100 can be operated by an operator in operator cabin 118. The operator can, for example, drive machine 100 to and from various locations on a work site and can also pick up and deposit loads of material using bucket 112 of implement 106. By further way of example, both operation by a remotely located operator and autonomous or robotic operation are contemplated. Machine 100 can be used to excavate a portion of a work site by actuating cylinders 114 to articulate bucket 112 via linkage assembly 110 to dig into and remove dirt, rock, sand, etc. from a portion of the work site and deposit this load in another location. Machine 100 can include a battery compartment connected to frame 102 and including a battery system 120. Battery system 120 is electrically coupled to the one or more electric motors of the battery electric machine (BEM) 100.

The electric motors of electric work machines are high voltage and high current. Electric motors with an internal permanent magnet (IPM) can experience back-EMF failure. In a back-EMF failure mode, the speed control system of the electric motor fails and the loss of speed control can cause a very large freewheeling current to occur. This freewheeling current may reach the DC bus and impact components of the power system of the machine 100.

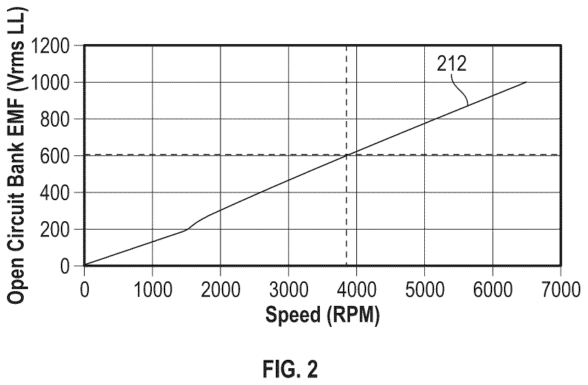

FIG. 2 is an illustration of an operating curve 212 of Back-EMF root-mean-square volts (Vrms) versus rotor speed in revolutions per minute (rpm) for an electric motor. The operating curve 212 shows that the freewheeling current resulting from rotor speeds greater than 3750 rpm can lead to bus voltages that exceed 850V. It is useful to protect a DC bus from back-EMF failure faults or freewheeling current faults.

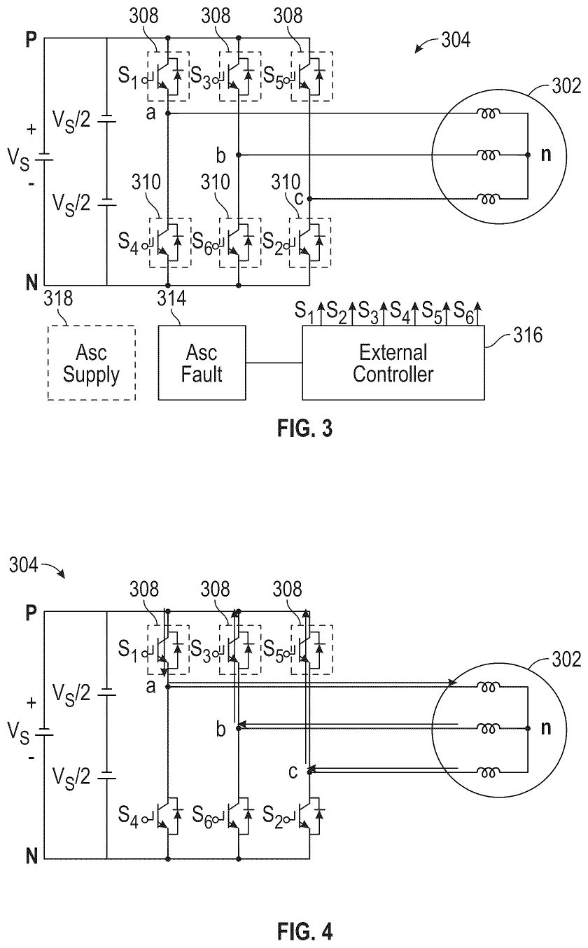

FIG. 3 is a circuit diagram of an example of portions of a switching inverter circuit for a three-phase alternating current (AC) electric motor 302. The inverter circuit 304 consists of three inverter legs-one inverter leg for each phase. Each inverter leg produces an output displaced 120 degrees with respect to the other inverter legs. The switches of the inverter legs are Insulated Gate Bipolar Transistors (IGBTs). There is a set of top IGBTs 308 and a set of bottom IGBTs 310. Switching of the IGBTs is controlled by an external controller 316 in normal operation. The external controller 316 includes logic circuitry to generate control signals (S1, S2, . . . S6) for the six IGBTs in normal operation. One of the two IGBTs in an inverter leg are on at any instant in normal operation of the inverter circuit 304.

An approach to protect the machine 100 from a freewheeling current fault is Active Short Circuit (ASC). The external controller 316 may include a speed sensor to monitor the speed of the rotor of the electric motor 302. The external controller 316 detects when the rotor speed of the electric motor exceeds a specified threshold speed (e.g., 3750 rpms). When a speed greater than the threshold speed is detected, the external controller 316 produces drive outputs to actively short circuit the phases of the electric motor 302 by activating (i.e., turning on) either all the top IGBTs 308 at the same time, or all the bottom IGBTs 310 at the same time. The top IGBT 308 and the bottom IGBT 310 of any inverter leg are not on at the same time to avoid shoot-through currents.

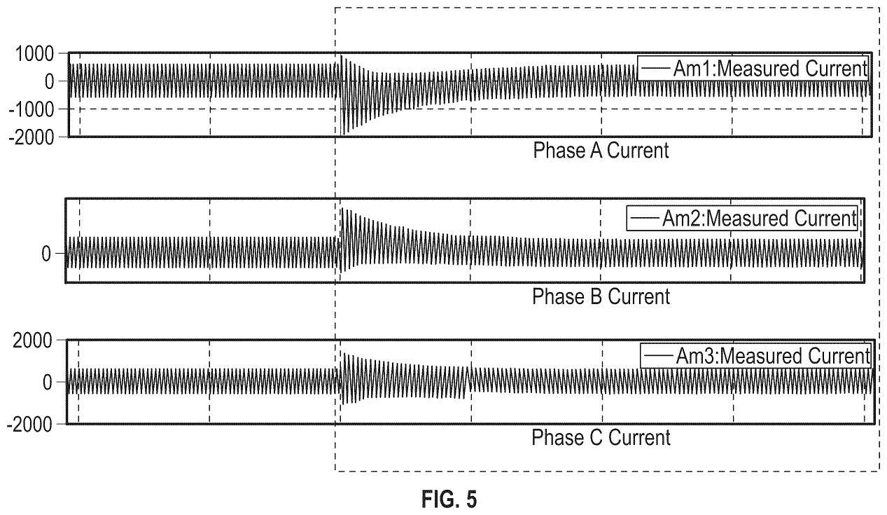

FIG. 4 is a circuit diagram of an example of the inverter circuit 304 in ASC mode. The top IGBTs 308 are activated by the external controller 316 in response to the rotor speed of the electric motor exceeding the specified threshold speed.

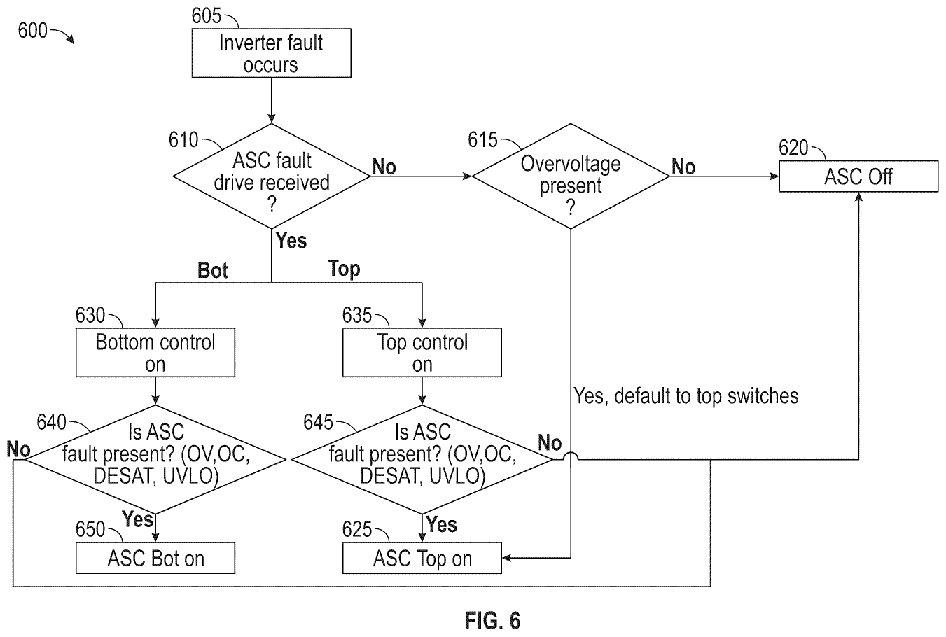

FIG. 5 is an illustration of examples of phase current transients when the inverter circuit enters ASC mode. The peak current depends on motor speed and the peak will increase with motor speed. FIG. 5 shows that the transient current waveforms are asymmetric and the waveforms will vary depending on position of the rotor when ASC mode is activated. The peak current transients create high power loss on the circuit die of the inverter top IGBTs 308 or bottom IGBTs 310. The three phases (shown as phase a, b, c in FIG. 4) will be stressed differently due to the asymmetric transient current waveform.

Returning to FIG. 3, the circuit diagram shows an ASC Fault circuit 314 included with the inverter circuit 304. The ASC Fault circuit 314 includes logic circuitry to manage the different types of faults that can occur in addition to a freewheeling current fault. The logic circuitry identifies inverter circuit faults applicable for ASC activation (i.e., ASC critical faults) and enhances management of inverter faults through the ability to switch between top IGBTs and bottom IGBTs for the ASC mode. The logic circuitry of the ASC Fault circuit 314 also mitigates risks associated with loss of communication between the external controller 316 and the ASC Fault circuit 314. A dedicated ASC backup circuit supply 318 mitigates risk of failure of main power to the inverter circuit 304. In some examples, the backup circuit supply 318 is powered from the high voltage DC bus of the electrical system of the work machine.

The ASC critical faults that can impact ASC mode include the DC Bus Overvoltage fault (DC_OV_FAULT) when voltage of the DC link exceeds a specified threshold voltage (e.g., 850V peak voltage). Other ASC critical faults include a DC link Overcurrent fault (DC_OC_ FAULT), an AC phase over-current fault (AC_Phase_OC_ FAULT) that can result from a short inside the electric motor 302, desaturation (DESAT_ FAULT) of one or more of the IGBTs, a main power supply under voltage lock out fault (PS_UVLO_FLT), and a gate drive under voltage lock out fault (UVLO_ FAULT). Other faults that can be managed using the external controller 316 include a ground fault drive under voltage lock out (GFD_FAULT) and a high voltage lamp fault (HVL_FAULT) indicating a problem with the lamp that alerts the operator of the presence of high voltage.

The logic circuitry of the ASC Fault circuit 314 adds a layer of control to the fault detection and mitigation for the external controller 316. For instance, the internal ASC fault circuit 314 is configured to detect an overvoltage or other ASC critical fault for the switching inverter circuit. When an ASC critical fault is present, the external controller 316 determines if rotor speed of the electric motor exceeds a specified threshold speed. The threshold motor speed may be the rotor speed threshold used to detect back-EMF failure mode and freewheeling current faults. If the ASC critical fault is present and the rotor speed is greater than the threshold speed, the ASC Fault circuit 314 will activate a set of IGBT drives. The external controller 316 may enable activation of the drive signals by the ASC Fault circuit 314 to one of the sets of top IGBTs 308 or the set of bottom IGBTs 310. When the overvoltage fault is present and the rotor speed is less than the threshold speed or no control is received from the external controller 316, the internal ASC fault circuit 314 activates one of the sets of IGBTs 308 or 310 by default. This fault detection may protect against freewheeling currents when communication with the external controller is lost, or the speed sensor has failed.

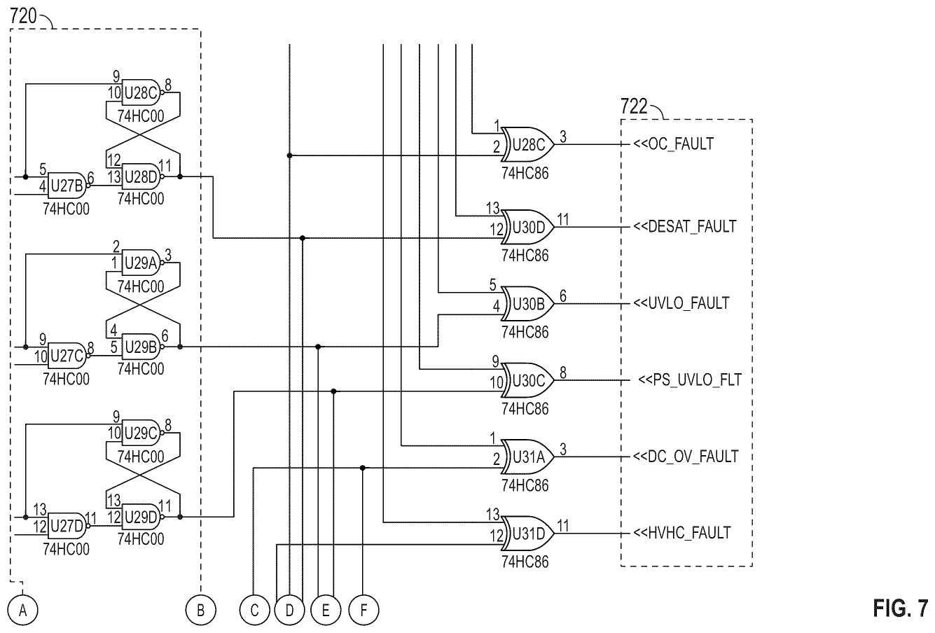

FIG. 6 is an example of a logic diagram 600 for fault detection that can be implemented by the logic circuitry of the ASC Fault circuit 314. At block 605, an inverter fault occurs. The logic may include a logical “OR” of the sensing circuits that detects faults in the inverter circuit 304.

At block 610, it is determined whether an ASC mode IGBT control signal output from the external controller 316 is active and received by the ASC Fault circuit 314. The IGBT control signal output activates the top set of IGBTs or the bottom set of IGBTs, and the IGBT control signal being present means that the external controller 316 has detected a high rotor speed that could result in a back-EMF failure event or freewheeling current fault. If an IGBT control signal output from the external controller 316 is not received, at block 615, it is determined if overvoltage is present on the DC bus. If overvoltage is not present, at block 620, the ASC Fault circuit 314 disables the IGBT drive signal output of the external controller 316. If overvoltage is present on the DC bus, but there is no control signal output from the external controller 316, at block 625, the ASC Fault circuit 314 activates a default ASC mode that activates IGBT switches. In the examples of FIG. 6, the default is to activate all the top IGBTs 308. In the alternative, the default may be to activate all the bottom IGBTs 310.

Returning to block 610, if an IGBT control signal output from the external controller 316 is received, a machine speed above the threshold speed has been detected. The ASC Fault circuit 314 enables the bottom IGBT control signal output from the external controller 316 at block 630, or enables the top IGBT control signal output from the external controller at block 635; depending on whether the ASC mode of the external controller 316 drives all the bottom IGBTs 310 or all the top IGBTs 308.

At the point in the logic diagram after block 630 or block 635, the ASC Fault circuit 314 has received information that the external controller 316 has detected an excessive motor speed and has asserted its control signal output for ASC mode. At blocks 640 and 645, the ASC Fault circuit 314 checks that the inverter fault at block 605 is a fault for which ASC mode should be entered. The ASC Fault circuit 314 determines whether the inverter circuit fault includes one or more of an overvoltage (OV) fault, an over current (OC) fault, an IGBT desaturation (DESAT) fault, or a IGBT under voltage lockout (UVLO) fault. If the inverter circuit fault detected is not one of the OV, OC, DESAT, or UVLO faults, the ASC Fault circuit 314 disables the control signal output of the external controller 316 at block 620.

If the inverter circuit fault is one of the OV, OC, DESAT, or UVLO faults, the control signal output from the external controller 316 is enabled by the ASC Fault circuit and the control signal output activates the set of all the bottom IGBTs 310 at 650 or the drive signal output activates the set of all the top IGBTs 308 at 625. The logic circuitry of the ASC Fault circuit 314 may check that only one control signal output for the top IGBTs or the bottom IGBTs is active. If both control signal outputs are active, the ASC Fault circuit 314 may override the control signal outputs from the external controller 316 and activate its default switches in the ASC mode (e.g., activate the top IGBTs 308 at 625 and block activation of the bottom IGBTs 310). It can be seen from the logic diagram 600, that the ASC Fault circuit 314 provides hardware control over enable of the ASC mode independent of the control of the external controller 316.

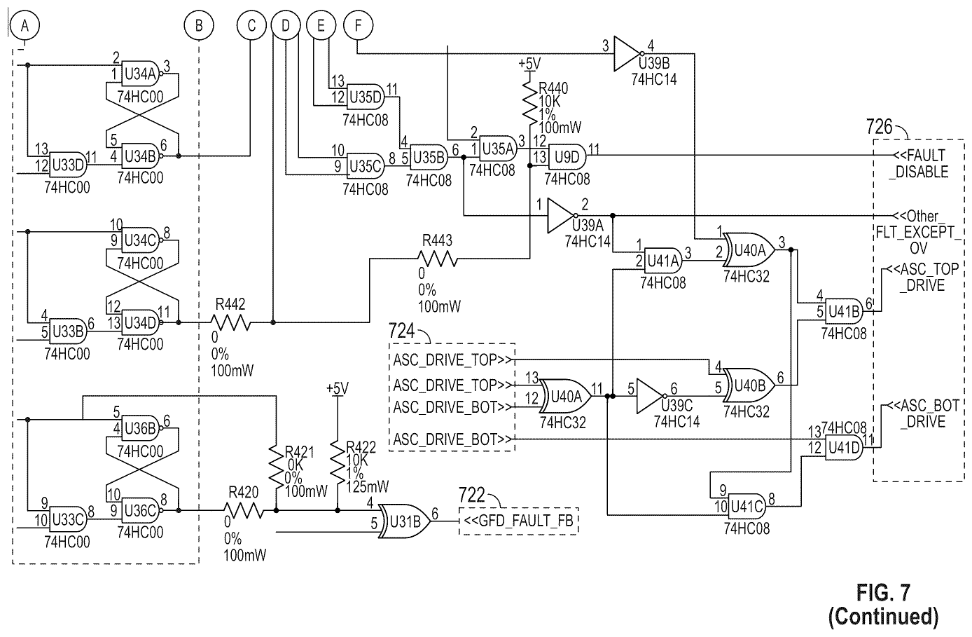

FIG. 7 is a circuit diagram of an example of logic circuitry to implement the logic diagram 600 of FIG. 6. On the left in the diagram are latch circuits (e.g., SR latches 720). If the output of a latch circuit is low, detection of the fault corresponding to the latch circuit was tripped. If the output of the latch circuit is high the corresponding fault was not detected. On the right are some examples of faults 722 detected by the external controller 316. The faults 722 in the example of FIG. 7 include OC_ FAULT, DESAT_ FAULT, UVLO_ FAULT, PS_UVLO_FLT, DC_OV_FAULT, high voltage high current fault (HVHC_FAULT), and GFD_FAULT (bottom of FIG. 7). Other implementations can detect a different set of faults including more faults or less faults.

In addition to the faults 722, other inputs to the logic circuitry include ASC drive signal outputs 724 (ASC_DRIVE_TOP, ASC_DRIVE_BOT) from the external controller 316. Outputs of the logic circuitry 726 include a drive signal sent to the top IGBTs (ASC_TOP_DRIVE) and a drive signal sent to the bottom IGBTs (ASC_BOT_DRIVE). Other outputs of the logic circuitry of the ASC Fault circuit 314 include a signal indicating that the fault detected is a fault other than an overvoltage fault (Other_FLT_EXCEPT_OV), and a fault disable signal (FAULT_DISABLE).

The control scheme with the ASC Fault circuit for enhanced fault management provides protection from back-EMF failure without relying solely on the external controller 316 or direct speed sensors of the electric motors. The control scheme also mitigates risks associated with power failure to the inverter and loss of communication between the external controller 316 and the ASC Fault circuit 314.

### INDUSTRIAL APPLICABILITY

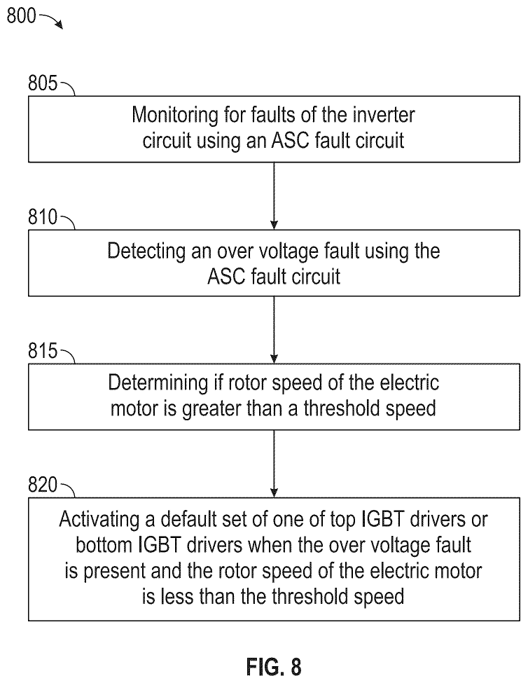

FIG. 8 is a flow diagram of an example of a method 800 of operating an inverter circuit of an electric motor. The method 800 may be performed using the three phase switching inverter circuit example of FIG. 3 that includes an external controller, such as the external controller 316 in FIG. 3, and an ASC Fault circuit (e.g., ASC Fault circuit 314 in FIG. 3) that may be integrated with the switching inverter circuit.

At block 805, the ASC Fault circuit 314 monitors for faults of the inverter circuit 304. In some examples, the ASC Fault circuit 314 monitors for an overvoltage fault and one or more of an over current fault, an IGBT desaturation fault, or a IGBT under voltage lockout fault. The ASC Fault circuit 314 may monitor for other faults such as a ground fault or power supply fault. At block 810, the ASC Fault circuit 314 detects an overvoltage fault. The overvoltage may indicate that a voltage on the DC bus is greater than a specified threshold voltage (e.g., a threshold voltage of 850V).

At block 815, the ASC Fault circuit 314 determines whether the rotor speed of the electric motor is greater than a specified threshold speed when the overvoltage fault is present. In some examples, the ASC Fault circuit 314 may receive an indication of the rotor speed from a rotor speed sensor included in the switching inverter circuit and determine that the rotor speed exceeds the threshold speed using the output of the rotor speed sensor. In some examples, the ASC Fault circuit 314 determines whether the rotor speed exceeds the threshold speed using the ASC mode IGBT control signal outputs of the external controller 316 of the switching inverter circuit. If one of the IGBT control signal outputs of the external controller 316 is active, the external controller 316 has detected that the rotor speed exceeds the threshold speed.

If the ASC Fault circuit 314 determines that there is an overvoltage volt and the rotor speed exceeds the specified threshold speed, the ASC Fault circuit 314 may enable activation of one of the top set of IGBT devices or the bottom set of IGBT devices by the external controller 316 depending on the ASC mode control signal output of the external controller 316. If the ASC Fault circuit 314 determines that there is an overvoltage volt and determines that the rotor speed is less than the specified threshold speed, the ASC Fault circuit 314 may activate a default set of one of top IGBT drivers or bottom IGBT drivers at block 820. Thus, the ASC Fault circuit 314 initiates the ASC mode of the inverter circuit 304. The ASC Fault circuit 314 may determine that the rotor speed is less than the specified threshold speed by the output of a rotor speed sensor. In some examples, the ASC Fault circuit 314 determines that the rotor speed is less than the specified threshold speed when the ASC drive outputs of the external controller 316 are inactive.

In some examples, the ASC Fault circuit 314 detects when both of the control signal output for the top IGBTs and the control signal output for the bottom IGBTs from the external controller 316 are active at the same time. The ASC Fault circuit 314 activates its default IGBT drive output to ensure that only one of the top set of IGBTs are active or the bottom set of IGBTs are active during ASC mode of the inverter circuit 304.

The ASC Fault circuit 314 may enable an IGBT drive output when it detects ASC critical faults other than an overvoltage fault. In some examples, the ASC Fault circuit 314 enables the ASC drive output from the external controller 316 when determining one or more of an over current fault, an IGBT desaturation fault, or a IGBT under voltage lockout fault. The ASC Fault circuit 314 may disable an IGBT drive output when it detects a fault other than the overvoltage fault, over current fault, IGBT desaturation fault, or IGBT under voltage lockout fault. In some examples, the ASC Fault circuit 314 may disable an IGBT control signal output from the external controller 316 when the ASC Fault circuit 314 detects a fault other than the overvoltage fault, over current fault, IGBT desaturation fault, or IGBT under voltage lockout fault, and the rotor speed of the electric motor exceeds the specified threshold speed.

Unless explicitly excluded, the use of the singular to describe a component, structure, or operation does not exclude the use of plural such components, structures, or operations or their equivalents. The use of the terms “a” and “an” and “the” and “at least one” or the term “one or more,” and similar referents in the context of describing the invention (especially in the context of the following claims) are to be construed to cover both the singular and the plural, unless otherwise indicated herein or clearly contradicted by context. The use of the term “at least one” followed by a list of one or more items (for example, “at least one of A and B” or one or more of A and B”) is to be construed to mean one item selected from the listed items (A or B) or any combination of two or more of the listed items (A and B; A, A and B; A, B and B), unless otherwise indicated herein or clearly contradicted by context. Similarly, as used herein, the word “or” refers to any possible permutation of a set of items. For example, the phrase “A, B, or C” refers to at least one of A, B, C, or any combination thereof, such as any of: A; B; C; A and B; A and C; B and C; A, B, and C; or multiple of any item such as A and A; B, B, and C; A, A, B, C, and C; etc.

The above detailed description is intended to be illustrative, and not restrictive. The scope of the disclosure should, therefore, be determined with references to the appended claims, along with the full scope of equivalents to which such claims are entitled.

What is claimed is:

1. An electric circuit for an electric motor, the electric circuit comprising:
a switching inverter circuit including a set of top insulated gate bipolar transistors (IGBTs) and a set of bottom IGBTs configured to provide energy to the electric motor;
an external controller external to the switching inverter circuit and configured to:
control switching of the top IGBTs and the bottom IGBTs in normal operation; and
activate one of a top IGBT control signal output to activate the set of top IGBTs or a bottom IGBT control signal output to activate the bottom IGBTs in response to detecting an event in which rotor speed of the electric motor exceeds a specified threshold speed; and
an Active Short Circuit (ASC) Fault circuit configured to:
detect an overvoltage fault for the switching inverter circuit;
determine if rotor speed of the electric motor exceeds the specified threshold speed when the overvoltage fault is present; and
activate one of the set of top IGBTs or the set of bottom IGBTs when the overvoltage fault is present and the rotor speed is less than the threshold speed.

2. The electric circuit of claim 1,
wherein the ASC Fault circuit is configured to:
activate a default one of the one of the set of top IGBTs or the set of bottom IGBTs when the overvoltage fault is present and the top IGBT control output and the bottom IGBT control output of the external controller are both inactive.

3. The electric circuit of claim 1,
wherein the ASC Fault circuit is configured to:
disable the top IGBT control output and the bottom IGBT control output of the external controller when the overvoltage fault is present and the top IGBT control output and the top IGBT control output of the external controller are both active; and
activate a default one of the one of the set of top IGBTs or the set of bottom IGBTs.

4. The electric circuit of claim 1,
wherein the ASC Fault circuit is configured to:
receive an indication of a switching inverter circuit fault and an indication that the rotor speed exceeds the specified threshold speed; and
enable activation of the one of the top IGBT control signal output or the bottom IGBT control signal output of the external controller when the rotor speed of the electric motor exceeds the threshold speed.

5. The electric circuit of claim 4,
wherein the ASC Fault circuit is configured to enable activation of one of the top IGBT control output or the bottom IGBT control output when the rotor speed of the electric motor exceeds the threshold speed and the switching inverter circuit fault includes one of an over current fault, an IGBT desaturation fault, or an IGBT under voltage lockout fault.

6. The electric circuit of claim 4,
wherein the ASC Fault circuit is configured to disable activation of one of the top IGBT control output or the bottom IGBT control output when the rotor speed of the electric motor exceeds the threshold speed and the switching inverter circuit fault is not one of the overvoltage fault, an over current fault, an IGBT desaturation fault, or an IGBT under voltage lockout fault.

7. The electric circuit of claim 1, including a backup circuit supply for the switching inverter circuit and the ASC Fault circuit.

8. A method of operating an inverter circuit of an electric motor, the method comprising:
monitoring for faults of the inverter circuit using an Active Short Circuit (ASC) Fault circuit;
detecting an overvoltage fault using the ASC Fault circuit;
determining whether a rotor speed of the electric motor is greater than a specified threshold speed using an external controller external to the inverter circuit; and
activating a default set of one of top insulated gate bipolar transistor (IGBTs) or bottom IGBTs when the overvoltage fault is present and the rotor speed of the electric motor is less than the threshold speed.

9. The method of claim 8,
wherein determining whether the rotor speed of the electric motor is greater than the specified threshold speed includes detecting that an ASC mode control signal output of the external controller is active; and
wherein activating the default set of one of the top IGBTs or the bottom IGBTs includes activating the default one of the top IGBTs or the bottom IGBTs when the overvoltage fault is present and the ASC mode control signal output of the external controller is inactive.

10. The method of claim 8, including:
monitoring a top IGBT control signal output and a bottom IGBT control signal output of the external controller; and
activating the default set of top IGBTs or the bottom IGBTs when overvoltage is present and both of the top IGBT control signal output and the bottom IGBT control signal output of the ASC Fault circuit are active.

11. The method of claim 8, including:
detecting an inverter circuit fault and detecting that the rotor speed of the electric motor exceeds the threshold speed; and
enabling activation of one of a set of top IGBT devices or a set of bottom IGBT devices by the external controller when the rotor speed of the electric motor exceeds the threshold speed.

12. The method of claim 11,
wherein the determining the inverter circuit fault includes determining one or more of an over current fault, an IGBT desaturation fault, or a IGBT under voltage lockout fault.

13. The method of claim 11, including:
disabling the activation of one of the set of top IGBT devices or the set of bottom IGBT devices by the external controller when the rotor speed of the electric motor exceeds the threshold speed and the inverter circuit fault is not one of the overvoltage fault, an over current fault, an IGBT desaturation fault, or an IGBT under voltage lockout fault.

14. The method of claim 11, including:
disabling, by the ASC Fault circuit, IGBT control signal outputs from the external controller to the top IGBT devices and the bottom IGBT devices when the inverter circuit fault is a fault other than the overvoltage fault, an over current fault, an IGBT desaturation fault, or a IGBT under voltage lockout fault.

15. A fault-detection circuit for an electric motor, the fault-detection circuit comprising:
an external controller including a top insulated gate bipolar transistor (IGBT) control signal output and a bottom IGBT control signal output for IGBT devices of a switching inverter circuit, and configured to activate one of the top IGBT control signal output or the bottom IGBT control signal output in response to detecting rotor speed of the electric motor that exceeds a specified threshold speed; and
an Active Short Circuit (ASC) Fault circuit configured to:
determine an overvoltage fault for the switching inverter circuit;
determine when rotor speed of the electric motor exceeds a specified threshold speed; and
activate a default one of a set of top IGBTs or a set of bottom IGBTs when the overvoltage fault is present and the rotor speed is less than the specified threshold speed.

16. The fault-detection circuit of claim 15, wherein the ASC Fault circuit includes logic circuitry configured to activate the default one of a set of top IGBTs or a set of bottom IGBTs when the overvoltage fault is present and the top IGBT control output and the bottom IGBT control output of the external controller are both inactive.

17. The fault-detection circuit of claim 15, wherein the ASC Fault circuit includes logic circuitry configured to activate the default one of a set of top IGBTs or a set of bottom IGBTs and disable the top IGBT control signal output and the bottom IGBT control signal output of the external controller when the overvoltage fault is present and the top IGBT control signal output and the top IGBT control signal output of the external controller are both active.

18. The fault-detection circuit of claim 15, wherein the ASC Fault circuit includes logic circuitry configured to:
receive an indication of a switching inverter circuit fault and an indication that the rotor speed exceeds the specified threshold speed; and
enable one of the top IGBT control signal output or the bottom IGBT control signal output of the external controller in response to receiving the indications of the switching inverter circuit fault and the rotor speed exceeding the threshold speed.

19. The fault-detection circuit of claim 15,
including detection circuits to detect one or more of the overvoltage fault, an over current fault, an IGBT desaturation fault, and an IGBT under voltage lockout fault;
wherein the ASC Fault circuit includes logic circuitry configured to:
receive an indication of the rotor speed exceeding the specified threshold rotor speed;
receive an indication of one or more of the overvoltage fault, the over current fault, the IGBT desaturation fault, or the IGBT under voltage lockout fault; and
enable one of the top IGBT control output or the bottom IGBT control output of the external controller when receiving the indications of the rotor speed exceeding the threshold speed and the indication of one or more of the overvoltage fault, the over current fault, the IGBT desaturation fault, or the IGBT under voltage lockout fault.

20. The fault-detection circuit of claim 19, wherein the ASC Fault circuit includes logic circuitry configured to:
disable one of the top IGBT control output or the bottom IGBT control output of the external controller when receiving the indication of the rotor speed exceeding the threshold speed and not receiving an indication of any of the overvoltage fault, the over current fault, the IGBT desaturation fault, or the IGBT under voltage lockout fault.
